(19) United States
(12) Patent Application Publication
(10) Pub. No.: US 2019/0179189 A1
(43) Pub. Date: Jun. 13, 2019

(54) LIQUID CRYSTAL DISPLAY

(71) Applicant: Samsung Display Co., Ltd., Yongin-si (KR)

(72) Inventors: Heung Shik PARK, Seoul (KR); Ki Chul Shin, Seongnam-si (KR); Ho Kil Oh, Seoul (KR); Israel Esteban Lazo Martinez, Hwaseong-si (KR); Jae-Soo Jang, Suwon-si (KR)

(21) Appl. No.: 16/208,433

(22) Filed: Dec. 3, 2018

(30) Foreign Application Priority Data
Dec. 8, 2017 (KR) 10-2017-0168383

(51) Int. Cl. G02F 1/13363; G02F 1/1335

(52) U.S. Cl. CPC G02F 1/13363; G02F 1/133617; G02F 2413/14; G02F 2413/11; G02F 2413/12; G02F 1/133528

(57) ABSTRACT

A liquid crystal display including: a display panel including an upper panel, a lower panel, and a liquid crystal layer disposed therebetween; and a backlight unit configured to provide light to the display panel. The upper panel includes a color conversion layer and an upper polarizer that respectively include semiconductor nanocrystals, the lower panel includes at least one of a B-plate compensation layer and an A-plate compensation layer, and a lower polarizer, the upper polarizer is disposed at a lower portion of the color conversion layer, and at least one of the upper panel and the lower panel includes a negative type of C-plate compensation layer.

### CROSS-REFERENCE TO RELATED APPLICATION

This application claims priority from and the benefit of Korean Patent Application No. 10-2017-0168383, filed on Dec. 8, 2017, which is hereby incorporated by reference for all purposes as if fully set forth herein.

### BACKGROUND

### Field

Exemplary embodiments of the invention relate generally to a liquid crystal display.

### Discussion of the Background

A liquid crystal display may include two field generating electrodes, a liquid crystal layer, a color filter, and a polarization layer. Although light generated from a light source reaches a user through the liquid crystal layer, the color filter, and the polarization layer, loss of light may occur in the polarization layer, the color filter, and the like. To realize a display device having high color reproducibility and good image quality on a lateral surface thereof while decreasing loss of light, a display device including a color conversion layer using a semiconductor nanocrystal has been proposed.

In the display device including the color conversion layer, a polarizer may be positioned between the color conversion layer and the liquid crystal layer, and in this case, a contrast ratio may be degraded.

The above information disclosed in this Background section is only for understanding of the background of the inventive concepts, and, therefore, it may contain information that does not constitute prior art.

### SUMMARY

Exemplary embodiments of the present invention provide a liquid crystal display using a color conversion layer that has an improved contrast ratio by using a compensation film.

Additional features of the inventive concepts will be set forth in the description which follows, and in part will be apparent from the description, or may be learned by practice of the inventive concepts.

An exemplary embodiment of the present invention provides a liquid crystal display including: a display panel including an upper panel, a lower panel, and a liquid crystal layer positioned between the upper panel and the lower panel; and a backlight unit configured to provide light to the display panel. The upper panel includes a color conversion layer and an upper polarizer that respectively include semiconductor nanocrystals, the lower panel includes a B-plate compensation layer and a lower polarizer, at least one of the upper panel and the lower panel includes a negative type of C-plate compensation layer, the upper polarizer is positioned at a lower portion of the color conversion layer, and the negative type of C-plate compensation layer is positioned between the upper polarizer and the lower polarizer, and is positioned on the upper panel or the lower panel.

An Rₜₕ (out-of-plane retardation) value of the negative type of C-plate compensation layer may be in a range of 80 nm to 200 nm.

The B-plate compensation layer may have an optically biaxial characteristic, an Rₒ (in-plane retardation) value thereof may be in a range of 40 nm to 100 nm, and an Rₜₕ (out-of-plane retardation) value thereof may be in a range of 80 nm to 190 nm.

The backlight unit may provide blue light to the display panel, and the blue light may have a wavelength in a range of 430 nm to 465 nm.

The liquid crystal layer may contain liquid crystal molecules, the liquid crystal molecules may be vertically arranged when an electric field is not applied thereto, and the liquid crystal layer may cause retardation of 240 nm to 350 nm in total with respect to the blue light provided by the backlight unit.

When viewed from a lateral surface at a predetermined position, an angle formed by a transmissive axis of the upper polarizer based on a transmissive axis of the lower polarizer is referred to as a lateral transmissive angle, light vertically polarized with respect to the lateral transmissive angle may be incident on the upper polarizer when black is displayed.

The lateral surface at the predetermined position may be positioned in a region in which lateral light leakage is large.

The upper panel may include the negative type of C-plate compensation layer; in the upper panel, the negative type of C-plate compensation layer may be positioned at a lower portion of the upper polarizer; and in the lower panel, the B-plate compensation layer may be positioned at an upper portion of the lower polarizer.

The lower panel may include the negative type of C-plate compensation layer; and in the lower panel, the B-plate compensation layer may be positioned at an upper portion of the lower polarizer and the negative type of C-plate compensation layer may be positioned at an upper portion of the B-plate compensation layer.

The negative type of C-plate compensation layer may be formed by coating a material causing retardation thereat, and the semiconductor nanocrystals of the color conversion layer may have a Lambertian radiation characteristic to emit obliquely emitted light toward a front surface.

Another embodiment of the present invention provides a liquid crystal display including: a display panel including an upper panel, a lower panel, and a liquid crystal layer positioned between the upper panel and the lower panel; and a backlight unit configured to provide light to the display panel. The upper panel includes a color conversion layer and an upper polarizer that respectively include semiconductor nanocrystals, the lower panel includes an A-plate compensation layer and a lower polarizer, at least one of the upper panel and the lower panel includes a negative type of C-plate compensation layer, the upper polarizer is positioned at a lower portion of the color conversion layer, and the negative type of C-plate compensation layer is positioned between the upper polarizer and the lower polarizer, and is positioned on the upper panel or the lower panel.

An Rₜₕ (out-of-plane retardation) value of the negative type of C-plate compensation layer may be in a range of 130 nm to 300 nm.

The A-plate compensation layer may have an optically biaxial characteristic, an Ro (in-plane retardation) value thereof may be in a range of 70 nm to 180 nm, and an Rth (out-of-plane retardation) value thereof may be in a range of 10 nm to 90 nm.

The backlight unit may provide blue light to the display panel, and the blue light may have a wavelength in a range of 430 nm to 465 nm.

The liquid crystal layer may contain liquid crystal molecules, the liquid crystal molecules may be vertically arranged when an electric field is not applied thereto, and the liquid crystal layer may cause retardation of 240 nm to 350 nm in total with respect to the blue light provided by the backlight unit.

When viewed from a lateral surface at a predetermined position, an angle formed by a transmissive axis of the upper polarizer based on a transmissive axis of the lower polarizer is referred to as a lateral transmissive angle, light vertically polarized with respect to the lateral transmissive angle may be incident on the upper polarizer when black is displayed.

The lateral surface at the predetermined position may be positioned in a region in which lateral light leakage is large.

The upper panel may include the negative type of C-plate compensation layer; in the upper panel, the negative type of C-plate compensation layer may be positioned at a lower portion of the upper polarizer; and in the lower panel, the A-plate compensation layer may be positioned at an upper portion of the lower polarizer.

The lower panel may include the negative type of C-plate compensation layer; and in the lower panel, the A-plate compensation layer may be positioned at an upper portion of the lower polarizer and the negative type of C-plate compensation layer may be positioned at an upper portion of the A-plate compensation layer.

The negative type of C-plate compensation layer may be formed by coating a material causing retardation thereat, and the semiconductor nanocrystals of the color conversion layer may have a Lambertian radiation characteristic to emit obliquely emitted light toward a front surface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a schematic view of a liquid crystal display according to an exemplary embodiment.

FIG. 2(A) and FIG. 2(B) illustrate movement of liquid crystals according to an electric field in an exemplary embodiment.

FIG. 3(A), FIG. 3(B), FIG. 3(C), and FIG. 3(D) illustrate a comparison diagram of a polarization characteristic of light and light leakage in an exemplary embodiment and a comparative example.

FIG. 4(A) and FIG. 4(B) illustrate transmittance of light respectively measured after transmission through a polarizer and after transmission through a color conversion layer.

FIG. 5(A) and FIG. 5(B) illustrate transmissive axes of a polarizer at front and lateral surfaces, respectively.

FIG. 6 is a spherical coordinate diagram shown so as to grasp the polarization characteristic of light according to position in a liquid crystal display.

FIG. 7(A), FIG. 7(B), FIG. 7(C), and FIG. 7(D) show spherical coordinate diagrams sequentially illustrating polarization changes of light according to the exemplary embodiment of FIG. 1.

FIG. 8 is a schematic view of a liquid crystal display according to another exemplary embodiment.

FIG. 9 illustrates a polarization characteristic of light in the exemplary embodiment of FIG. 8.

FIG. 10 illustrates a light polarization change according to the exemplary embodiment of FIG. 8.

FIG. 11 is a schematic view of a liquid crystal display according to another exemplary embodiment.

FIG. 12(A), FIG. 12(B), FIG. 12(C), and FIG. 12(D) are spherical coordinate diagrams sequentially showing polarization changes of light according to the exemplary embodiment of FIG. 11.

FIG. 13 is a schematic view of a liquid crystal display according to another exemplary embodiment.

FIG. 14 illustrates a graph for comparing differences of a contrast ratio between an exemplary embodiment of the present invention and a comparative example.

### DETAILED DESCRIPTION

In the following description, for the purposes of explanation, numerous specific details are set forth in order to provide a thorough understanding of various exemplary embodiments of the invention. As used herein “embodiments” are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

In the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

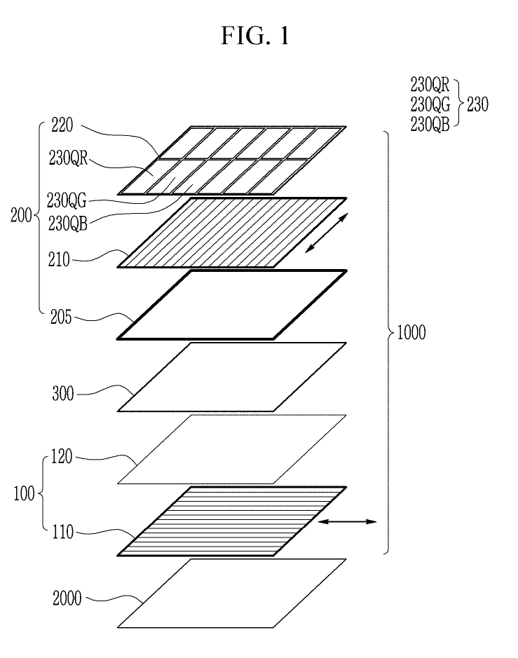

FIG. 1 is a schematic view of a liquid crystal display according to an exemplary embodiment.

A liquid crystal display includes a display panel 1000 and a backlight unit 2000.

The backlight unit 2000 provides blue light to the display panel 1000, and for this purpose, a blue light emitting diode (LED) may be included. The blue LED used in the present exemplary embodiment may have a wavelength in a range of 430 nm to 465 nm, and specifically, the blue LED may emit light of a 455 nm wavelength.

In addition, the blue light is vertically incident on a lower surface of the display panel 1000, and the backlight unit 2000 may include various optical sheets, such as a prism sheet, a diffusion sheet, a reflection sheet, and a brightness enhancement film in order to have high light efficiency.

The display panel 1000 includes a lower panel 100, an upper panel 200, and a liquid crystal layer 300 positioned between the lower panel 100 and the upper panel 200.

The lower panel 100 includes a lower polarizer 110 and a B-plate compensation layer 120. Further, the lower panel 100 includes a TFT substrate (not shown).

The TFT substrate (not shown) includes a transparent substrate, and a gate line and a data line extend in different directions on an upper surface of the transparent substrate. In addition, a thin film transistor (TFT) provided with a control terminal and an input terminal respectively connected to the gate line and the data line is formed on the transparent substrate, and a pixel electrode is connected to an output terminal of the thin film transistor (TFT). The thin film transistor (TFT) applies a voltage to the pixel electrode depending on a signal applied to the gate line and the data line.

The lower polarizer 110 and the B-plate compensation layer 120 may be attached to a lower surface of the TFT substrate. In this case, the B-plate compensation layer 120 is attached to the lower surface of the TFT substrate, and the lower polarizer 110 is attached under the B-plate compensation layer 120. In some exemplary embodiments, the B-plate compensation layer 120 may be positioned at an upper portion of the TFT substrate, and the lower polarizer 110 may be attached to the lower surface of the TFT substrate.

The lower polarizer 110 has a transmissive axis oriented in one direction, and blocks light in a direction perpendicular to the transmissive axis. The lower polarizer 110 may be attached as a film type, may be coated with a polymeric material, or may be formed with a plurality of metal wires having minute intervals. The plurality of metal wires may have a structure so as to be arranged in one direction at intervals that are smaller than a wavelength of light.

The B-plate compensation layer 120 is positioned on an upper portion of the lower polarizer 110. The B-plate compensation layer 120 may be a film having an optically biaxial characteristic, and its in-plane retardation (Rₒ) value may be in a range of 40 nm to 100 nm, while its out-of-plane retardation (Rₜₕ) may be in a range of 80 nm to 190 nm. In the present exemplary embodiment, the B-plate compensation layer 120 having the Rₒ value of 70 nm and the Rₜₕ value of 135 nm is used.

The upper panel 200 includes a color conversion layer 230, a light blocking layer 220, an upper polarizer 210, and a C-plate compensation layer 205. The upper panel 200 also includes a transparent substrate (not shown), and the light blocking layer 220 and the color conversion layer 230 may be positioned inside the transparent substrate, the upper polarizer 210 may be positioned thereunder, and the C-plate compensation layer 205 may be positioned thereunder.

The light blocking layer 220 divides regions in which respective color conversion layers 230QR, 230QG, and 230QB are formed, so that light passing through adjacent color conversion layers 230 is not mixed.

Respective color conversion layers 230QR, 230QG, and 230QB are alternately arranged in respective regions divided by the light blocking layer 220. The color conversion layers 230QR, 230QG, and 230QB may be variously arranged, and in the exemplary embodiment of FIG. 1, the red color conversion layer 230QR, the green color conversion layer 230QG, and the blue color conversion layer 230QB are alternately arranged in order of red, green, and blue along a row direction. In addition, the red color conversion layer 230QR, the green color conversion layer 230QG, and the blue color conversion layer 230QB have a structure in which color conversion layers 230 of the same color are positioned along a column direction. The red color conversion layer 230QR and the green color conversion layer 230QG include semiconductor nanocrystals that convert blue light provided by the backlight unit 2000 into red and green light, respectively, and in some exemplary embodiments, a blue light cutting filter may be included therein. The blue light cutting filter may include a yellow color filter to convert the blue light provided by the backlight unit 2000 into white light. The blue light cutting filter may serve to prevent blue light that has not been converted from being emitted while passing through the red color conversion layer 230QR and the green color conversion layer 230QG.

The blue color conversion layer 230QB may be made of a transparent material. That is, it may display a blue color by emitting the blue light provided by the backlight unit 2000 as it is. No layer therefor may be formed, and in some exemplary embodiments, the blue color conversion layer 230QB may be formed as a transparent film to eliminate a step difference.

The upper polarizer 210 is positioned under the light blocking layer 220 and the color conversion layer 230.

The upper polarizer 210 has a transmissive axis oriented in one direction, and blocks light in a direction perpendicular to the transmissive axis. In the exemplary embodiment of FIG. 1, the transmissive axis of the upper polarizer 210 is perpendicular to the transmissive axis of the lower polarizer 110. Accordingly, when an electric field is not applied to a liquid crystal display using a vertically aligned liquid crystal, light entering the upper polarizer 210 is blocked without being emitted to the outside and, thus, black is displayed.

The upper polarizer 210 may be attached as a film type, may be coated with a polymeric material, or may be formed with a plurality of metal wires having minute intervals. The plurality of metal wires may have a structure to be arranged in one direction at intervals that are smaller than a wavelength of light.

The C-plate compensation layer 205 is positioned under the upper polarizer 210.

The C-plate compensation layer 205 is a uniaxial compensation film and retardation values provided in a direction in a plane are the same (nₓ=n_{y}), and a negative type of C-plate compensation layer of which a retardation value in a vertical direction is smaller (nₓ=n_{y}>n_{z}) than the retardation values in the plane is used. By definition, the retardation values provided in the direction in the plane are the same (nₓ=n_{y}), but an actually manufactured C-plate compensation layer 205 may have a slight difference between nₓ and n_{y}. The C-plate compensation layer 205 may have an out-of-plane retardation (Rₜₕ) value of 80 nm to 200 nm, and it may have an in-plane retardation (Rₒ) value of 0 nm because the Rₒ value is a difference between nₓ and n_{y} by definition, but an actually manufactured C-plate compensation layer 205 may have a small value close to 0. When the Rₒ value of the C-plate compensation layer 205 increases, since display quality may deteriorate, the C-plate compensation layer 205 having an allowable Rₒ value is used in some display devices. In the present exemplary embodiment, the C-plate compensation layer 205 having an Rₜₕ value of 140 nm is used.

The C-plate compensation layer 205 may be formed by coating a material providing the retardation therein, arranging the material in a predetermined direction, and then fixing it. For example, the C-plate compensation layer 205 may be formed by arranging a liquid crystal material by rubbing or light-aligning the liquid crystal material in a predetermined direction while coating the liquid crystal material, and then fixing it by heat treatment. In this case, the retardation value provided by the C-plate compensation layer 205 may be adjusted by a thickness of the coated material.

A common electrode (not shown) may be positioned inside the C-plate compensation layer 205. A common electrode of the upper panel 200 and the pixel electrode of the lower panel 100 generate an electric field.

The liquid crystal layer 300 is positioned between the lower panel 100 and the upper panel 200. The liquid crystal layer 300 may provide retardation of 240 nm to 350 nm with respect to the blue light provided by the backlight unit 2000, and in the present exemplary embodiment, the liquid crystal layer 300 provides retardation of 280 nm.

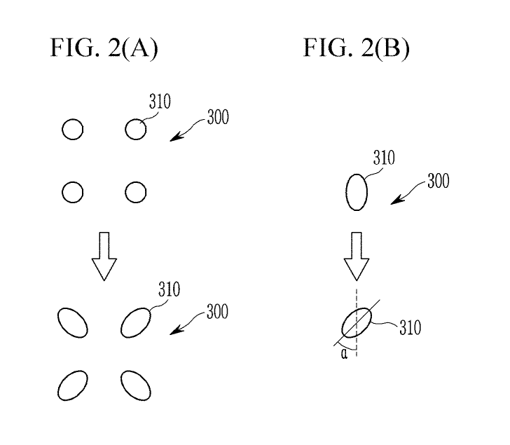

The liquid crystals in the liquid crystal layer 300 are vertically arranged when no electric field is applied, and the liquid crystals rotate to be horizontally arranged when an electric field is applied. This will be described in detail with reference to FIGS. 2(A) and 2(B).

FIGS. 2(A) and 2(B) illustrate movement of liquid crystals according to an electric field in an exemplary embodiment.

FIG. 2(A) is a top plan view showing an arrangement of liquid crystal molecules 310 according to an electric field when the display panel 1000 is viewed from above, and an arrow thereof indicates a change from before to after the electric field is applied.

Before the electric field is applied, the liquid crystal molecules 310 are viewed as having a circular shape when viewed from above. This means that the same retardation is provided in a plane direction (x or y direction) with respect to light propagating in a vertical direction (z direction). However, when an electric field is applied thereto, the liquid crystal molecules 310 rotate to be arranged in a direction perpendicular to a previous direction. Since the electric field is formed in the z direction, a component in the plane direction (x or y direction) increases so that the liquid crystal molecules 310 are arranged to be perpendicular to the z direction. As an intensity of the electric field increases, the component in the plane direction (x or y direction) is further increased. In the display panel 1000, the liquid crystal layer 300 may be divided into a plurality of domains, and in the same domain, the liquid crystal molecules 310 are arranged to lie in the same direction. Because the liquid crystal molecules 310 are arranged in four directions by the electric field, FIG. 2(A) shows an exemplary embodiment having four domains.

FIG. 2(B) is a cross-sectional view showing movement of a liquid crystal when the display panel 1000 is viewed from a lateral surface, and an arrow thereof indicates a change from before to after the electric field is applied.

When no electric field is applied, the liquid crystal molecules are arranged in the vertical direction (z direction), and are arranged in the plane direction when the electric field is applied, and the arranged angle (a) varies depending on the intensity of the electric field. The arranged angle (a) is an angle between the vertical direction (dotted line) and a long axis (solid line) of the liquid crystal molecule 310. As the electric field increases, the arranged angle increases.

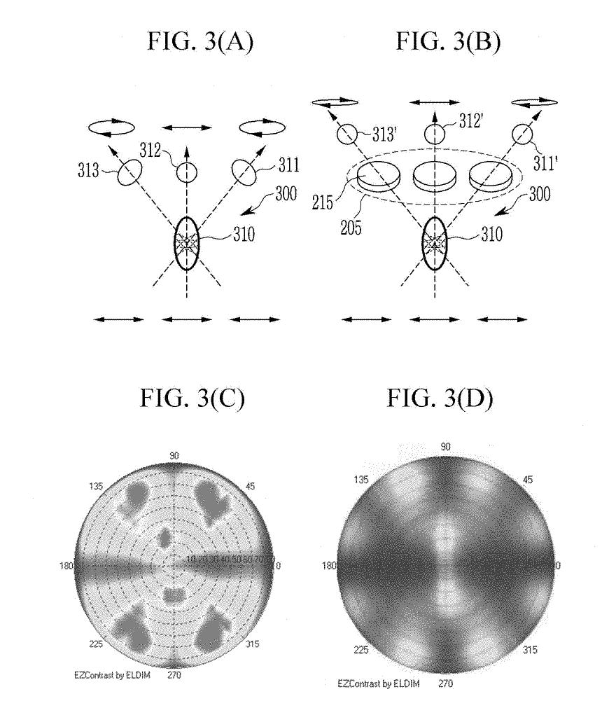

Hereinafter, a change in the polarization characteristic of light transmitted through the display panel 1000 and a light leakage phenomenon will be described with reference to FIGS. 3(A) to 3(D).

FIGS. 3(A) to 3(D) illustrate a comparison diagram of the polarization characteristic and leakage of light in an exemplary embodiment and a comparative example, wherein FIG. 3(A) and FIG. 3(C) illustrate the comparative example, and FIG. 3(B) and FIG. 3(D) illustrate the present exemplary embodiment.

FIGS. 3(A) to 3(D) illustrate a state up to a layer (i.e., the upper polarizer 210) before the color conversion layer 230 of the display panel 1000 in order to more easily confirm polarization of light.

First, in a display panel according to the comparative example, a change of the polarization characteristic of light will be described with reference to FIG. 3(A).

FIG. 3(A) illustrates a change of the polarization characteristic of light transmitted through an upper portion from a lower portion of the display panel in the comparative example. Unlike the present exemplary embodiment, the comparative example does not include the negative type of C-plate compensation layer 205.

As blue light provided by the backlight unit 2000 passes the lower polarizer 110 of the display panel, it is linearly-polarized in one direction. The backlight unit 2000 includes a plurality of sheets for passing through light in the vertical direction (z direction), and the light actually includes some obliquely proceeding light.

Although the light passing in an oblique direction shown in FIGS. 3(A) and 3(B) is shown to obliquely pass at a large angle with respect to the vertical direction, this is exaggeratedly shown, and the light actually passes at an angle closer to the vertical direction.

When light passes through a material providing the retardation, it is provided with retardation of a plane direction perpendicular to the passing direction of the light. That is, the retardation of the light passing through the liquid crystal molecules 310 is determined according to a cross-section (hereinafter referred to as a vertical cross-section) of the liquid crystal molecules 310 perpendicular to the passing direction. Based on this, FIG. 3(A) will now be described.

The vertical cross-section of the liquid crystal molecule 310 according to the light proceeding in the vertical direction (z direction) is circular. Therefore, there is no retardation in the plane direction (x and y directions) and, thus, the polarization characteristic is maintained without being changed. As a result, the light is blocked by the upper polarizer and, thus, black is displayed.

However, the vertical cross-sections of the liquid crystal molecule 310 according to the obliquely proceeding light have elliptical shapes 311 and 313. In this case, two retardations in the plane direction are different, and a phase of the light is changed, so that the light is not linearly-polarized but is instead elliptically-polarized. As a result, the light is not completely blocked by the upper polarizer but is partially leaked thereat.

FIG. 3(C) illustrates results of measuring leakage of light in the comparative example. That is, it can be seen that a large amount of light is leaked from a lateral surface in the comparative example.

However, the present exemplary embodiment includes the C-plate compensation layer 205, thereby reducing the light that is leaked from the lateral surface.

The polarization characteristic of light before being incident on the C-plate compensation layer 205 in FIG. 3(B) is the same as that in FIG. 3(A). However, the polarization characteristic of the light is changed as the light passes through the C-plate compensation layer 205, and accordingly, the component of the elliptical polarized light is reduced to be the linearly polarized light even for the obliquely proceeding light. This is due to the negative type of C-plate compensation layer 205.

The light proceeding in the vertical direction will now be described. The vertical cross-section of the liquid crystal molecules 310 according to the light proceeding in the vertical direction (z direction) is circular, and the vertical cross-section of a phase conversion material 215 included in the negative type of C-plate compensation layer 205 is circular, so that the light passing through the two layers undergoes retardation corresponding to a circular shape 312′. Thus, the same retardation is generated in the plane direction (x and y directions), so that the polarization characteristic is maintained without being changed. As a result, the light is blocked by the upper polarizer 210 and, thus, black is displayed.

On the other hand, the vertical cross-section of the liquid crystal molecules 310 according to the obliquely proceeding light is elliptical, and the vertical cross-section of the phase conversion material 215 included in the negative type of C-plate compensation layer 205 is elliptical. However, since the vertical cross-section of the phase conversion material 215 included in the negative type of C-plate compensation layer 205 is close to a circular shape, the retardation provided by the liquid crystal molecules 310 is reduced. That is, as the obliquely proceeding light passes through the liquid crystal layer 300 and the C-plate compensation layer 205, it undergoes retardation due to vertical sections (see 311′ and 313′) closer to circular, so that it is further linear-polarized compared to the comparative example. Accordingly, a greater amount of light is blocked by the upper polarizer 210 positioned at an upper side.

FIG. 3(D) illustrates results of measuring leakage of light in the present exemplary embodiment. That is, the leakage of light from the lateral surface in the present exemplary embodiment is greatly reduced as compared with that of the comparative example.

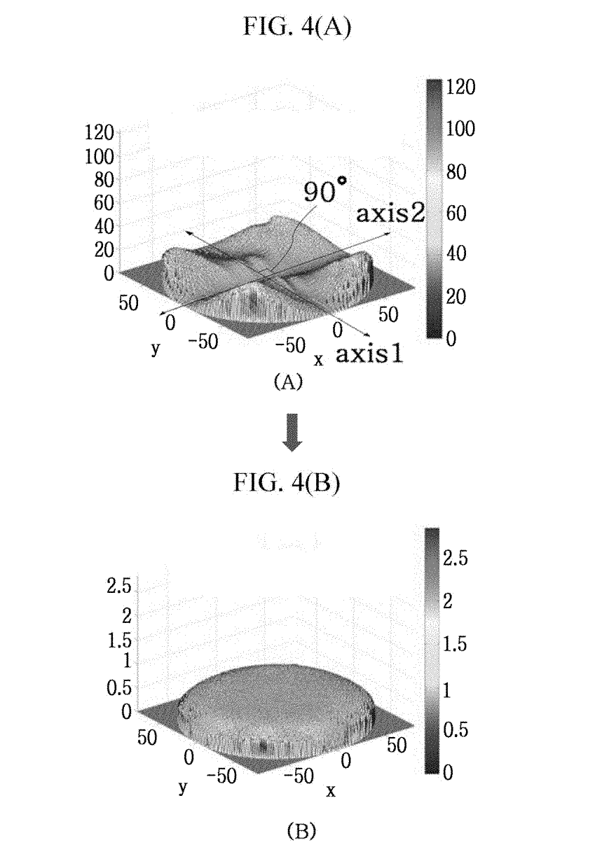

In FIGS. 3(A)-3(D), the polarization characteristic of light in a state in which the color conversion layer 230 is excluded from the display panel 1000 has been described. However, an actual display panel 1000 includes a color conversion layer 230 including semiconductor nanocrystals. Therefore, light obliquely emitted due to the Lambertian radiation characteristic of the semiconductor nanocrystals is also emitted toward a front surface. This means that the light is emitted to the front surface regardless of directionality of light incident due to the color conversion layer 230 including the semiconductor nanocrystals. This characteristic is shown in FIGS. 4(A) and 4(B).

FIG. 4(A) illustrates transmittance of light measured after passing through a polarizer, and FIG. 4(B) illustrates transmittance of light measured after passing through a color conversion layer.

That is, FIG. 4(A) illustrates an amount of light passing up to the upper polarizer 210. In FIG. 4(A), there is very little light leakage with respect to transmissive axes (axis 1 and axis 2) of the lower polarizer 110 and the upper polarizer 210. However, the light is maximally leaked at the vicinity of 45 degrees from the transmissive axis.

In FIG. 4(B), uniform leakage of light can be confirmed as a whole. FIG. 4(A) shows that even if light leakage occurs only at the lateral surface, all of the light is viewed from the front when the light passes through the color conversion layer 230. That is, due to the Lambertian radiation characteristic of the semiconductor nanocrystals resulting from Lambertian radiation and characteristics of the semiconductor nanocrystals, as the light leaking to the lateral surface is directed to the front, it is also viewed from the front.

The uniform light leakage, as shown in FIG. 4(B), causes the contrast ratio of the display panel 1000 to be reduced. Therefore, in the display panel 1000 including the color conversion layer 230 with the semiconductor nanocrystals, the light leakage should be reduced in all directions in order to reduce the contrast ratio. For this purpose, when the amount of light leaking to the lateral surface is reduced, the amount of light leaking to other portions is also reduced. Thus, the contrast ratio is improved.

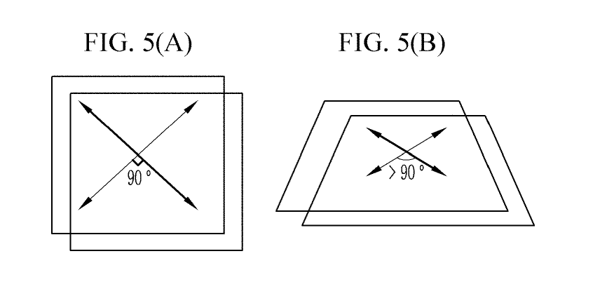

Characteristics of light proceeding to the lateral surface will now be described to reduce the light leaking to the lateral surface with reference to FIGS. 5(A) and 5(B).

FIGS. 5(A) and 5(B) illustrate transmissive axes of a polarizer at front and lateral surfaces.

FIG. 5(A) illustrates transmissive axes when two polarizers are viewed from above. As shown in FIG. 5(A), when the two polarizers are viewed from above (from the front of the display panel), the transmissive axes form an angle of 90 degrees.

However, when the two polarizers are viewed from the lateral surface, the angle formed by the two transmissive axes is not 90 degrees. That is, as shown in FIG. 5(B), when the transmissive axes of the two polarizers are obliquely viewed from the lateral surface, the angle formed by them appears to be greater than 90 degrees. This means a phenomenon in which the transmissive axes of the polarizer are obliquely viewed due to the light obliquely proceeding to the lateral surface. Hereinafter, the angle formed by the transmissive axis of the upper polarizer viewed from the lateral surface and by the transmissive axis of the lower polarizer is referred to as a “lateral transmissive angle”.

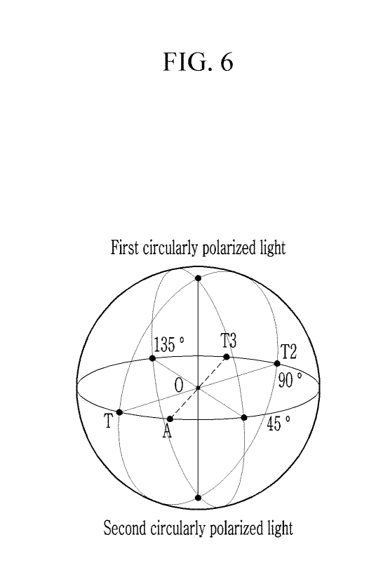

Before describing the present exemplary embodiment based on this, a spherical coordinate diagram to be used later will be described with reference to FIG. 6.

FIG. 6 is a spherical coordinate diagram to assist in understanding the polarization characteristic of light according to a position in a liquid crystal display.

The spherical coordinate diagram of FIG. 6 is also called the “Poincaré sphere”, and is a diagram in which a polarized state is applied to a sphere having a radius of 1. When the polarization characteristic of light is represented by a 3×3 matrix, the matrix may also be expressed as a vector. As such, when the vector showing the polarization characteristic of light is drawn in three-dimensional coordinates, the polarization characteristic is displayed on the spherical coordinate diagram as shown in FIG. 6.

In FIG. 6, polarization of the transmissive axis of the lower polarizer 110 is shown as “T” on the spherical coordinate diagram. In this case, since the transmissive axis of the upper polarizer 210 is 90 degrees with respect to the transmissive axis of the lower polarizer 110, it is shown as “T2”, which is the opposite of “T”. This is natural in consideration of the fact that the polarization axis becomes the same axis when rotated 180 degrees. Two points at which a straight line perpendicular to a straight line connecting T and T2 while passing through a center (0) meets with the spherical coordinate diagram are points to be 45 and 135 degrees with respect to the transmissive axis of the lower polarizer 110, respectively. In addition, two points at which a straight line extending in a direction perpendicular to a horizontal plane including T, T2, 45°, and 135° from the center (0) meets with the spherical coordinates are circularly polarized (first circularly polarized and second circularly polarized), wherein one is circularly polarized to the left and the other is circularly polarized to the right.

As described in FIG. 5(B), when viewed from the lateral surface, the angle formed by the transmissive axes of two polarizers is greater than 90°. As such, when viewed from the lateral surface, the transmissive axis of the upper polarizer 210 passes through 90° and is positioned at T3. That is, it has a value greater than 90°. T3 corresponds to the lateral transmissive angle. An accurate point of T3 is set based on a point where light leaks most, although it is different depending on a viewing position. In some exemplary embodiments, it may be set based on one position of a large region of lateral light leakage.

As such, when viewed from the lateral surface of the specific position, if the angle formed by the transmissive axes of the two polarizers is T3, light having an angle of 90° with respect to the polarization of T3 should be incident on the upper polarizer 210 in order to prevent light from leaking to the lateral surface of the specific position. This is the “A” position opposite to T3 on the spherical coordinate diagram of FIG. 6. Therefore, when the light having the polarization at the “A” position is provided to the upper polarizer 210, the obliquely proceeding light also has polarization perpendicular to the transmissive axis of the upper polarizer 210, so that the light is blocked and brightness for displaying black is reduced.

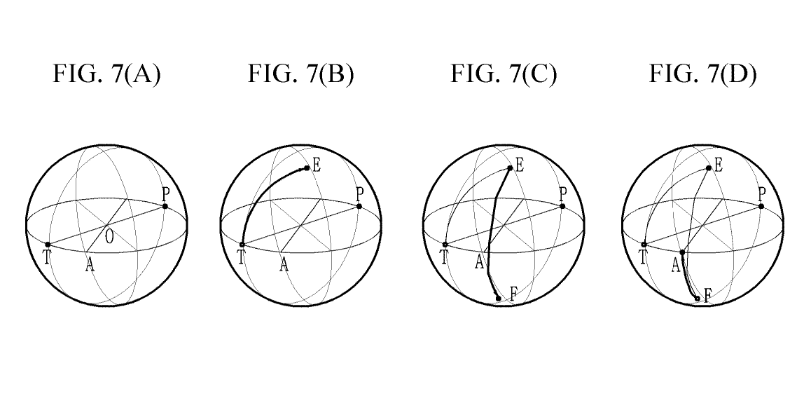

Considering this, a change of polarization characteristics according to the present exemplary embodiment will be described with reference to FIGS. 7(A)-7(D).

FIGS. 7(A)-7(D) are spherical coordinate diagrams sequentially illustrating polarization changes of light according to the exemplary embodiment of FIG. 1.

FIG. 7(A) illustrates polarization of the light transmitted through the lower polarizer 110; FIG. 7(B) illustrates polarization of the light transmitted through the B-plate compensation layer 120; FIG. 7(C) illustrates polarization of the light transmitted through the liquid crystal layer 300; and FIG. 7(D) illustrates polarization of the light transmitted through the negative type of C-plate compensation layer 205.

First, blue light provided by the backlight unit 2000 passes through the lower polarizer 110 and is linearly polarized. A direction of the transmissive axis of the lower polarizer 110 is shown as “T” on the spherical coordinate diagram. (See FIG. 7(A))

Then, when the B-plate compensation layer 120 transmits, the polarization of the light is changed to the “E” position. The “E” position may be varied according to compensation characteristics of the B-plate compensation layer 120, and the polarization thereat is one of elliptical polarizations. (See FIG. 7(B)) In the B-plate compensation layer 120 used in the present exemplary embodiment, Rₒ is 70 nm, and Rₜₕ is 135 nm.

Next, when the liquid crystal layer 300 transmits, the polarization of the light is changed to the “F” position. The “F” position may also be varied according to retardation characteristics of the liquid crystal layer 300, wherein the polarization thereat is one of elliptical polarizations, and is elliptical polarization in an opposite direction of the “E” position. (See FIG. 7(C)) In the present exemplary embodiment, the liquid crystal layer is formed of a material providing retardation of 280 nm, and is formed to have a thickness providing it.

Then, when the negative type of C-plate compensation layer 205 transmits, the polarization is changed to a linear polarization of the “A” position. Since the “A” position is perpendicular to the transmissive axis of the upper polarizer 210 when viewed from the lateral surface, the upper polarizer 210 does not transmit. Accordingly, black is clearly displayed, and light leakage does not occur. In the present exemplary embodiment, Rₜₕ of the negative type of C-plate compensation layer 205 is 140 nm. An Rₒ value of the C-plate compensation layer 205 is a very small value close to 0.

Since the light leakage does not occur even at the lateral surface, black brightness does not increase even when the Lambertian radiation characteristic of the semiconductor nanocrystals of the color conversion layer 230 is considered. Accordingly, the contrast ratio is improved.

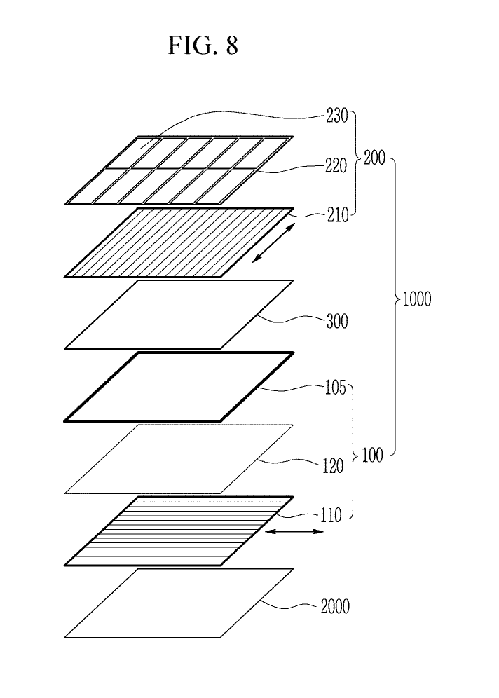

Hereinafter, another exemplary embodiment of the present invention will be described with reference to FIG. 8.

FIG. 8 illustrates a schematic view of a liquid crystal display according to another exemplary embodiment.

Unlike the exemplary embodiment of FIG. 1, a negative type of C-plate compensation layer 105 is included in the lower panel 100 of FIG. 8.

The liquid crystal display includes the display panel 1000 and the backlight unit 2000.

The backlight unit 2000 provides blue light to the display panel 1000, and for this purpose, a blue LED may be included. The blue LED used in the present exemplary embodiment may have a wavelength range of 430 nm to 465 nm, and specifically, it emits light of a 455 nm wavelength.

In addition, the blue light is vertically incident on a lower surface of the display panel 1000, and the backlight unit 2000 may include various optical sheets, such as a prism sheet, a diffusion sheet, a reflection sheet, and a brightness enhancement film to provide high light efficiency.

The display panel 1000 includes the lower panel 100, the upper panel 200, and the liquid crystal layer 300 positioned between the lower panel 100 and the upper panel 200.

The lower panel 100 includes the lower polarizer 110, the B-plate compensation layer 120, and the C-plate compensation layer 105. Although not shown, the lower panel 100 includes a TFT substrate.

The TFT substrate (not shown) includes a transparent substrate, and a gate line and a data line extend in different directions on an upper surface of the transparent substrate. In addition, a thin film transistor (TFT) provided with a control terminal and an input terminal respectively connected to the gate line and the data line is formed on the transparent substrate, and a pixel electrode is connected to an output terminal of the thin film transistor (TFT). The thin film transistor (TFT) applies a voltage to the pixel electrode depending on a signal applied to the gate line and the data line.

The lower polarizer 110, the B-plate compensation layer 120, and the C-plate compensation layer 105 may be attached to the lower surface of the TFT substrate. In this case, the C-plate compensation layer 105 is attached to the lower surface of the TFT substrate, the B-plate compensation layer 120 is attached thereunder, and the lower polarizer 110 is attached thereunder. In some exemplary embodiments, the B-plate compensation layer 120 and the C-plate compensation layer 105 may be positioned at an upper portion of the TFT substrate, and the lower polarizer 110 may be attached to the lower surface of the TFT substrate. In this case, the B-plate compensation layer 120 is positioned under the C-plate compensation layer 105.

The lower polarizer 110 has a transmissive axis in one direction, and blocks light in a direction perpendicular to the transmissive axis. The lower polarizer 110 may be attached as a film type, may be coated with a polymeric material, or may be formed with a plurality of metal wires having minute intervals. The plurality of metal wires may be arranged in one direction at intervals that are narrower than a wavelength of light.

The B-plate compensation layer 120 is positioned on the upper portion of the lower polarizer 110. The B-plate compensation layer 120 may be a film having an optically biaxial characteristic, and its in-plane retardation (Rₒ) value may be in a range of 40 nm to 100 nm, while its out-of-plane retardation (Rₜₕ) may be in a range of 80 nm to 190 nm. In the present exemplary embodiment, the B-plate compensation layer 120 having the Rₒ value of 70 nm and the Rₜₕ value of 135 nm is used.

The C-plate compensation layer 105 is positioned at an upper portion of the B-plate compensation layer 120. The C-plate compensation layer 105 is a uniaxial compensation film and retardation values provided in a direction in a plane are the same (nₓ=n_{y}), and a negative type of C-plate compensation layer of which a retardation value in a vertical direction is smaller (nₓ=n_{y}>n_{z}) than the retardation values in the plane is used. By definition, the retardation values provided in the direction in the plane are the same (nₓ=n_{y}), but an actually manufactured C-plate compensation layer 105 may have a slight difference between nₓ and n_{y}. The C-plate compensation layer 105 may have an out-of-plane retardation (Rₜₕ) value of 80 nm to 200 nm, and it preferably has an in-plane retardation (Rₒ) value of 0 nm because the Rₒ value is a difference between nₓ and n_{y} by definition, but an actually manufactured C-plate compensation layer 105 may have a small value. When the Rₒ value increases, since display quality may deteriorate, the C-plate compensation layer 205 having an allowable Rₒ value is used in some display devices. In the present exemplary embodiment, the C-plate compensation layer 105 having the Rₜₕ value of 140 nm is used.

The C-plate compensation layer 105 may be formed as a film type and be attached to a lower portion of the TFT substrate (not shown). Further, in some exemplary embodiments, it may be positioned inside the TFT substrate (not shown). The C-plate compensation layer 105 positioned inside the TFT substrate (not shown) may be positioned on a transparent part of the TFT substrate (not shown) to be positioned below or on the thin film transistor. The C-plate compensation layer 105 may be formed by coating a material providing the retardation, arranging the material in a predetermined direction, and then fixing it. For example, the C-plate compensation layer 105 may be formed by arranging a liquid crystal material by rubbing or light-aligning the liquid crystal material in a predetermined direction while coating the liquid crystal material, and then fixing it by heat treatment. In this case, the retardation value provided by the C-plate compensation layer 105 may be adjusted by a varying the thickness of the coated material.

The upper panel 200 includes the color conversion layer 230, the light blocking layer 220, and the upper polarizer 210. The upper panel 200 also includes a transparent substrate (not shown), and the light blocking layer 220 and the color conversion layer 230 may be positioned inside the transparent substrate, while the upper polarizer 210 may be positioned thereunder.

The light blocking layer 220 divides regions in which respective color conversion layers 230 are formed, so that light passing through the adjacent color conversion layers 230 is not mixed.

Red, green, and blue color conversion layers 230 are alternately arranged in respective regions divided by the light blocking layer 220. The red, green, and blue color conversion layers 230 may be variously arranged.

The red and green color conversion layers include semiconductor nanocrystals that convert light provided by the backlight unit 2000 into red and green light, respectively, and in some exemplary embodiments, a blue light cutting filter may be included therein. The blue light cutting filter may include a yellow color filter to convert the blue light provided by the backlight unit 2000 into white light. On the other hand, the blue light cutting filter may serve to prevent blue light that has not been converted from being emitted while passing through the red and green color conversion layers 230.

The blue color conversion layer 230 may be made of a transparent material. That is, the blue color conversion layer 230 may display a blue color by emitting the blue light provided by the backlight unit 2000 as it is. No layer therefor may be formed, and in some exemplary embodiments, it may be formed as a transparent film to eliminate a step difference.

The upper polarizer 210 is positioned under the light blocking layer 220 and the color conversion layer 230.

The upper polarizer 210 has a transmissive axis in one direction, and blocks light in a direction perpendicular to the transmissive axis. In the exemplary embodiment of FIG. 8, the transmissive axis of the upper polarizer 210 is perpendicular to the transmissive axis of the lower polarizer 110. Accordingly, when an electric field is not applied to a display device using a vertically aligned liquid crystal, light entering the upper polarizer 210 from a lower portion is blocked without being emitted to the outside, thus black is displayed.

The upper polarizer 210 may be attached as a film type, may be coated with a polymeric material, or may be formed with a plurality of metal wires having minute intervals. The plurality of metal wires may have a structure to be arranged in one direction at intervals that are smaller than a wavelength of light.

A common electrode (not shown) may be positioned inside the upper polarizer 210. The common electrode of the upper panel 200 and the pixel electrode of the lower panel 100 generate an electric field.

The liquid crystal layer 300 is positioned between the lower panel 100 and the upper panel 200. The liquid crystal layer 300 may provide retardation of 240 nm to 350 nm with respect to the blue light provided by the backlight unit 2000, and in the present exemplary embodiment, the liquid crystal layer 300 provides retardation of 280 nm.

The liquid crystals in the liquid crystal layer 300 are vertically arranged when no electric field is applied, and the liquid crystals rotate to be horizontally arranged when an electric field is applied.

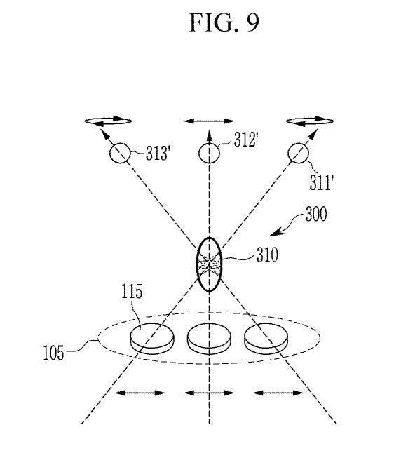

Hereinafter, the polarization characteristic of the light transmitted through the display panel 1000 will be described with reference to FIG. 9.

FIG. 9 illustrates the polarization characteristic of light in the exemplary embodiment of FIG. 8.

FIG. 9 illustrates a state up to a layer (i.e., the upper polarizer 210) before the color conversion layer 230 of the display panel 1000 in order to more easily confirm polarization of light.

Comparing FIG. 9 with FIG. 3(A), it can be seen that an elliptically polarized component of light incident on the upper polarizer 210 in FIG. 9 is reduced so that the light is nearly linear-polarized.

Light proceeding in a vertical direction will be described with reference to FIG. 9. The vertical cross-section of the liquid crystal molecules 310 according to the light proceeding in the vertical direction (z direction) is circular, and the vertical cross-section of a phase conversion material 115 included in the negative type of C-plate compensation layer 105 is circular, so that the light passing through the two layers undergoes retardation corresponding to a circular shape 312′. Thus, the same retardation is generated in the plane direction (x and y directions), so that the polarization characteristic is maintained without being changed. As a result, the light is blocked by the upper polarizer 210, thereby resulting in black being displayed.

On the other hand, the vertical cross-section of the liquid crystal molecules 310 according to the obliquely proceeding light is elliptical, and the vertical cross-section of the phase conversion material 115 included in the negative type of C-plate compensation layer 105 is an elliptical shape similar to a circular shape. As a result, as the obliquely proceeding light passes through the liquid crystal layer 300 and the C-plate compensation layer 105, the obliquely proceeding light undergoes retardation due to vertical sections (see 311′ and 313′) closer to circular, so that it is further linear-polarized compared to the comparative example of FIG. 3(A). Accordingly, a larger amount of light is blocked by the upper polarizer 210 positioned at an upper side.

In FIG. 9, the polarization characteristic of light in a state in which the color conversion layer 230 is excluded from the display panel 1000 has been described. However, an actual display panel 1000 includes a color conversion layer 230 including semiconductor nanocrystals. Therefore, light obliquely emitted due to the Lambertian radiation characteristic of the semiconductor nanocrystals is also emitted toward a front surface. This is because the color conversion layer 230 including the semiconductor nanocrystals emits light toward the front surface irrespective of directionality of light incident on the color conversion layer 230.

Therefore, in order to lower brightness when displaying black, it is also necessary to reduce the light leaking to the lateral surface. In addition, as shown in FIG. 5(B), when being viewed from the lateral surface, the angle formed by the two transmissive axes of the upper polarizer 210 and the lower polarizer 110 looks like an angle (lateral transmissive angle) of greater than 90°. As such, the display panel 1000 should be configured such that light is incident on the upper polarizer 210 at an angle of 90° with respect to the angle (lateral transmissive angle) of the transmissive axis of the upper polarizer 210 when viewed from the lateral surface. However, the angle (lateral transmissive angle) of the transmissive axis of the upper polarizer 210 varies depending on the angle viewed from the lateral surface, and since the polarization characteristic is changed in accordance with the liquid crystal layer 300 or the compensation layer (B-plate compensation layer, C-plate compensation layer) that is used, the angle (lateral transmissive angle) may be in various numerical ranges. Hereinafter, an experiment based on an angle at which the largest light leakage occurs will be described.

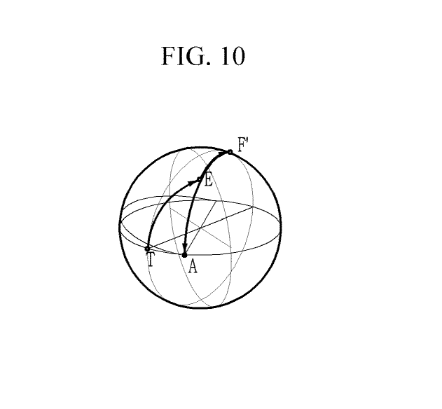

Considering this, a change in the polarization characteristic according to the exemplary embodiment of FIG. 8 will be described with reference to FIG. 10.

FIG. 10 illustrates a light polarization change according to an exemplary embodiment of FIG. 8.

Unlike FIGS. 7(A)-7(D), the change of the polarization characteristic is shown with one arrow in one spherical coordinate diagram in FIG. 10.

First, the blue light provided by the backlight unit 2000 passes through the lower polarizer 110 and is linearly polarized. A direction of the transmissive axis of the lower polarizer 110 is shown as “T” on the spherical coordinate diagram.

Then, when the B-plate compensation layer 120 transmits, the polarization of the light is changed to the “E” position. The “E” position may be varied according to compensation characteristic of the B-plate compensation layer 120, and the polarization thereat is one of elliptical polarizations. In the B-plate compensation layer 120 used in the present exemplary embodiment, Rₒ is 70 nm and Rₜₕ is 135 nm.

Next, when the negative type of C-plate compensation layer 105 transmits, the polarization of light is changed to the “F′” position. The “F′” position may also be varied according to the retardation characteristic of the liquid crystal layer 300, wherein the polarization thereat is one of elliptical polarizations, and is elliptical polarization in the same direction as that of the “E” position. In the present exemplary embodiment, Rₜₕ of the negative type of C-plate compensation layer 205 is 140 nm. The Rₒ value of the C-plate compensation layer 205 is a very small value close to 0.

Then, when the liquid crystal layer 300 transmits, the polarization of the light is changed to the “A” position. Since the “A” position is perpendicular to the transmissive axis of the upper polarizer 210 when viewed from the lateral surface, the upper polarizer 210 does not transmit. Accordingly, black is clearly displayed, and light leakage does not occur. In the present exemplary embodiment, the liquid crystal layer is formed of a material providing retardation of 280 nm, and is formed to have the requisite thickness to provide it.

Since light leakage does not occur even at the lateral surface, black brightness does not increase even when the Lambertian radiation characteristic of the semiconductor nanocrystals of the color conversion layer 230 is considered. Accordingly, the contrast ratio is improved.

Referring to FIG. 10, as in the exemplary embodiment of FIG. 1, the exemplary embodiment of FIG. 8 also shows that the light leakage at the lateral surface is reduced with respect to the upper polarizer 210. Therefore, it can be seen that the contrast ratio characteristic of the display device including the color conversion layer 230 with the semiconductor nanocrystals is improved regardless of whether the C-plate compensation layer is positioned on the upper panel 200 or on the lower panel 100.

The display panel 1000 including the B-plate compensation layer and the negative type of C-plate compensation layer has been described above. Hereinafter, the display panel 1000 including the negative type of C-plate compensation layer and an A-plate compensation layer will be mainly described.

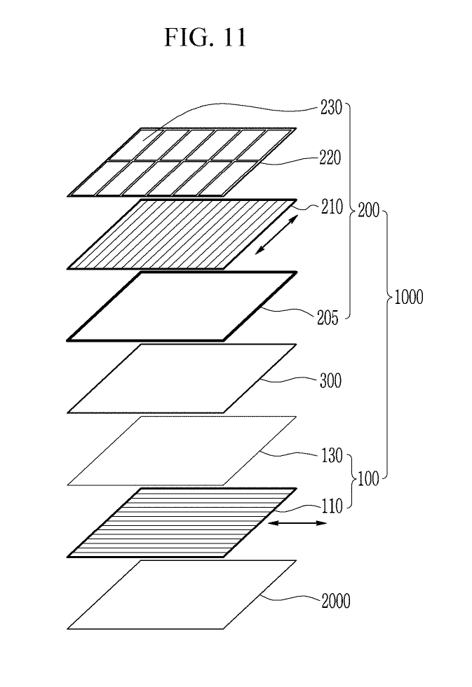

FIG. 11 illustrates a schematic view of a liquid crystal display according to another exemplary embodiment.

The liquid crystal display includes the display panel 1000 and the backlight unit 2000.

The backlight unit 2000 provides blue light to the display panel 1000, and for this purpose, a blue LED may be included. The blue LED used in the present exemplary embodiment may have a wavelength in a range of 430 nm to 465 nm, and specifically, the blue LED emits light of a 455 nm wavelength.

In addition, the blue light is vertically incident on a lower surface of the display panel 1000, and the backlight unit 2000 may include various optical sheets, such as a prism sheet, a diffusion sheet, a reflection sheet, and a brightness enhancement film, in order to produce high light efficiency.

The display panel 1000 includes the lower panel 100, the upper panel 200, and the liquid crystal layer 300 positioned between the lower and upper panels.

The lower panel 100 includes the lower polarizer 110 and an A-plate compensation layer 130. Although not shown, the lower panel 100 includes a TFT substrate.

The TFT substrate (not shown) includes a transparent substrate, and a gate line and a data line extending in different directions on an upper surface of the transparent substrate. In addition, a thin film transistor (TFT) provided with a control terminal and an input terminal respectively connected to the gate line and the data line is formed on the transparent substrate, and a pixel electrode is connected to an output terminal of the thin film transistor (TFT). The thin film transistor (TFT) applies a voltage to the pixel electrode depending on a signal applied to the gate line and the data line.

The lower polarizer 110 and the A-plate compensation layer 130 may be attached to the lower surface of the TFT substrate. In this case, the A-plate compensation layer 130 is attached to the lower surface of the TFT substrate, and the lower polarizer 110 is attached thereunder. In some exemplary embodiments, the A-plate compensation layer 130 may be positioned at an upper portion of the TFT substrate, and the lower polarizer 110 may be attached to the lower surface of the TFT substrate.

The lower polarizer 110 has a transmissive axis in one direction, and blocks light in a direction perpendicular to the transmissive axis. The lower polarizer 110 may be attached as a film type, may be coated with a polymeric material, or may be formed with a plurality of metal wires having minute intervals. The plurality of metal wires may have a structure to be arranged in one direction at intervals that are smaller than a wavelength of light.

The A-plate compensation layer 130 is positioned on the lower polarizer 110. The A-plate compensation layer 130 may be a film having an optically uniaxial characteristic, and the A-plate compensation layer 130 provides retardation of which a vertical direction is the same as one of the plane directions (x and y directions). Other retardation is provided in the other of the plane directions (x and y directions). In the exemplary embodiment of the present invention, an Rₒ (in-plane retardation) value of the A-plate compensation layer 130 may be in a range of 70 nm to 180 nm, and an Rₜₕ (out-of-plane retardation) value thereof may be in a range of 10 nm to 90 nm. In the present exemplary embodiment, the A-plate compensation layer 130 having the Rₒ value of 130 nm and the Rₜₕ value of 65 nm is used.

The upper panel 200 includes the color conversion layer 230, the light blocking layer 220, the upper polarizer 210, and the C-plate compensation layer 205. The upper panel 200 also includes a transparent substrate (not shown), the light blocking layer 220 and the color conversion layer 230 may be positioned inside the transparent substrate, the upper polarizer 210 may be positioned thereunder, and the C-plate compensation layer 205 may be positioned thereunder.

The light blocking layer 220 divides regions in which respective color conversion layers 230 are formed, so that light passing through adjacent color conversion layers 230 is not mixed.

The red, green, and blue color conversion layers 230 are alternately arranged in respective regions divided by the light blocking layer 220. The red, green, and blue color conversion layers 230 may be variously arranged.

The red and green color conversion layers include semiconductor nanocrystals that convert light provided by the backlight unit 2000 into red and green light, respectively, and in some embodiments, a blue light cutting filter may be included therein. The blue light cutting filter may include a yellow color filter to convert the blue light provided by the backlight unit 2000 into white light. On the other hand, the blue light cutting filter may serve to prevent blue light that has not been converted from being emitted while passing through the red and green color conversion layers 230.

The blue color conversion layer 230 may be made of a transparent material. That is, the blue color conversion layer 230 displays a blue color by emitting the blue light provided by the backlight unit 2000 as it is. No layer therefor may be formed, and in some exemplary embodiments, the blue color conversion layer 230 may be formed as a transparent film to eliminate a step difference.

The upper polarizer 210 is positioned under the light blocking layer 220 and the color conversion layer 230.

The upper polarizer 210 has a transmissive axis in one direction, and blocks light in a direction perpendicular to the transmissive axis. In the exemplary embodiment of FIG. 11, the transmissive axis of the upper polarizer 210 is perpendicular to the transmissive axis of the lower polarizer 110. Accordingly, when an electric field is not applied to a display device using a vertically aligned liquid crystal, light entering the upper polarizer 210 from a lower portion is blocked without being emitted to the outside. Thus, black is displayed.

The upper polarizer 210 may be attached as a film type, may be coated with a polymeric material, or may be formed with a plurality of metal wires having minute intervals. The plurality of metal wires may have a structure to be arranged in one direction at intervals that are narrower than a wavelength of light.

The C-plate compensation layer 205 is positioned under the upper polarizer 210.

The C-plate compensation layer 205 is a uniaxial compensation film and retardation values provided in a direction in a plane are the same (nₓ=n_{y}), and a negative type of C-plate compensation layer of which a retardation value in a vertical direction is less (nₓ=n_{y}>n_{z}) than the retardation values in the plane is used. By definition, the retardation values provided in the direction in the plane are the same (nₓ=n_{y}), but an actually-manufactured C-plate compensation layer 205 may have a slight difference between nₓ and n_{y}. The C-plate compensation layer 205 may have an out-of-plane retardation (Rₜₕ) value of 130 nm to 300 nm, and it may have an in-plane retardation (Rₒ) value of 0 nm because the Rₒ value is a difference between nₓ and n_{y} by definition, but an actually manufactured C-plate compensation layer 205 may have a small value close to 0. When the Rₒ value of the C-plate compensation layer 205 increases, since display quality may deteriorate, the C-plate compensation layer 205 having an allowable Rₒ value is used in some display devices. In the present exemplary embodiment, the C-plate compensation layer 205 having the Rₜₕ value of 220 nm is used.

The C-plate compensation layer 205 may be formed by coating a material providing the retardation therein, arranging the material in a predetermined direction, and then fixing it. For example, it may be formed by arranging a liquid crystal material by rubbing or light-aligning the liquid crystal material in a predetermined direction while coating the liquid crystal material, and then fixing it by heat treatment. In this case, the retardation value provided by the C-plate compensation layer 205 may be adjusted by a thickness of the coated material.

A common electrode (not shown) may be positioned inside the C-plate compensation layer 205. The common electrode of the upper panel 200 and the pixel electrode of the lower panel 100 generate an electric field.

The liquid crystal layer 300 is positioned between the lower panel 100 and the upper panel 200. The liquid crystal layer 300 may provide retardation of 240 nm to 350 nm with respect to the blue light provided by the backlight unit 2000, and in the present exemplary embodiment, the liquid crystal layer 300 provides retardation of 280 nm.

The liquid crystals in the liquid crystal layer 300 are vertically arranged when no electric field is applied, and the liquid crystals rotate to be horizontally arranged when an electric field is applied.

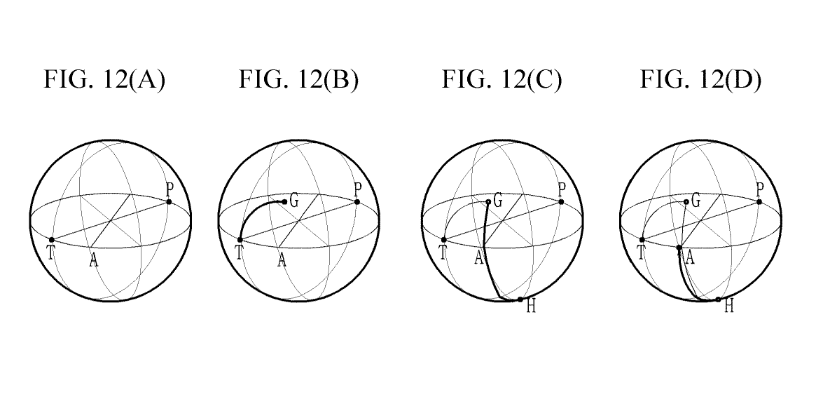

Hereinafter, the polarization characteristic of the light transmitted through the display panel 1000 will be described with reference to FIGS. 12(A)-12(D).

FIGS. 12(A)-12(D) shows spherical coordinate diagrams sequentially illustrating polarization changes of light according to an exemplary embodiment of FIG. 11.

As shown in FIG. 12(A), the blue light provided by the backlight unit 2000 passes through the lower polarizer 110 and is linearly polarized. A direction of the transmissive axis of the lower polarizer 110 is shown as “T” on the spherical coordinate diagram.

Then, as shown FIG. 12(B), when the A-plate compensation layer 130 transmits, the polarization of the light is changed to the “G” position. The “G” position may be varied according to the compensation characteristic of the A-plate compensation layer 130, and the polarization thereat is one of elliptical polarizations. Rₒ of the A-plate compensation layer 130 used in the present exemplary embodiment is 130 nm, and Rₜₕ thereof is 65 nm.

Next, as shown in FIG. 12(C), when the negative type of C-plate compensation layer 205 transmits, the polarization of the light is changed to the “H” position. The “H” position may also be varied according to the retardation characteristic of the C-plate compensation layer 205, the polarization thereat is one of elliptical polarizations, and is elliptical polarization in an opposite direction of the “G” position. In the present exemplary embodiment, Rₕ of the negative type of C-plate compensation layer 205 is 220 nm. The Rₒ value of the C-plate compensation layer 205 is a very small value close to 0.

Then, as shown in FIG. 12(D), when the liquid crystal layer 300 transmits, the polarization of the light is changed to the “A” position. Since the “A” position is perpendicular to the transmissive axis of the upper polarizer 210 when viewed from the lateral surface, the upper polarizer 210 does not transmit. Accordingly, black is clearly displayed, and light leakage does not occur. In the present exemplary embodiment, the liquid crystal layer is formed of a material providing retardation of 280 nm, and is formed to have the requisite thickness to provide it.

Since the light leakage does not occur even at the lateral surface, black brightness does not increase even when the Lambertian radiation characteristic of the semiconductor nanocrystals of the color conversion layer 230 is considered. Accordingly, the contrast ratio is improved.

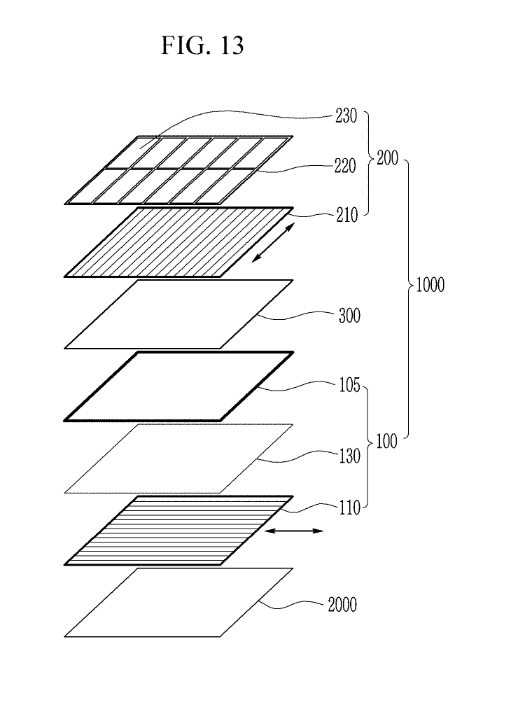

Hereinafter, an exemplary embodiment that includes the A-plate compensation layer 130 and in which the C-plate compensation layer is positioned at the lower panel 100 will be described with reference to FIG. 13.

FIG. 13 illustrates a schematic view of a liquid crystal display according to another exemplary embodiment.

The liquid crystal display includes the display panel 1000 and the backlight unit 2000.

The backlight unit 2000 provides blue light to the display panel 1000, and for this purpose, a blue LED may be included. A blue LED used in the present exemplary embodiment may have a wavelength in a range of 430 nm to 465 nm, and specifically, the blue LED emits light of a 455 nm wavelength.

In addition, the blue light is vertically incident on a lower surface of the display panel 1000, and the backlight unit 2000 may include various optical sheets such as a prism sheet, a diffusion sheet, a reflection sheet, and a brightness enhancement film to have high light efficiency.

The display panel 1000 includes the lower panel 100, the upper panel 200, and the liquid crystal layer 300 positioned between the lower and upper panels.

The lower panel 100 includes the lower polarizer 110, the A-plate compensation layer 130, and the C-plate compensation layer 105. Although not shown, the lower panel 100 includes a TFT substrate (not shown).

The TFT substrate (not shown) includes a transparent substrate, and a gate line and a data line extend in different directions on an upper surface of the transparent substrate. In addition, a thin film transistor (TFT) provided with a control terminal and an input terminal respectively connected to the gate line and the data line is formed on the transparent substrate, and a pixel electrode is connected to an output terminal of the thin film transistor (TFT). The thin film transistor (TFT) applies a voltage to the pixel electrode depending on a signal applied to the gate line and the data line.

The lower polarizer 110, the A-plate compensation layer 130, and the C-plate compensation layer 105 may be attached to the lower surface of the TFT substrate. In this case, the C-plate compensation layer 105 is attached to the lower surface of the TFT substrate, the A-plate compensation layer 130 is attached thereunder, and the lower polarizer 110 is attached thereunder. In some exemplary embodiments, the A-plate compensation layer 130 and the C-plate compensation layer 105 may be positioned at an upper portion of the TFT substrate, and the lower polarizer 110 may be attached to the lower surface of the TFT substrate. In this case, the A-plate compensation layer 130 is positioned under the C-plate compensation layer 105.

The lower polarizer 110 has a transmissive axis in one direction, and blocks light in a direction perpendicular to the transmissive axis. The lower polarizer 110 may be attached as a film type, may be coated with a polymeric material, or may be formed with a plurality of metal wires having minute intervals. The plurality of metal wires may be arranged in one direction at intervals that are smaller than a wavelength of light.

The A-plate compensation layer 130 is positioned at the upper portion of the upper portion of the lower polarizer 110. The A-plate compensation layer 130 may be a film having the optically uniaxial characteristic, and the A-plate compensation layer 130 provides retardation of which a vertical direction is the same as one of the plane directions (x and y directions). Other retardation is provided in the other of the plane directions (x and y directions). In the exemplary embodiment of the present invention, the Rₒ (in-plane retardation) value of the A-plate compensation layer 130 may be in a range of 70 nm to 180 nm, and the Rₜₕ (out-of-plane retardation) value thereof may be in a range of 10 nm to 90 nm. In the present exemplary embodiment, the A-plate compensation layer 130 having the Rₒ value of 130 nm and the Rₜₕ value of 65 nm is used.

The C-plate compensation layer 105 is positioned at an upper portion of the A-plate compensation layer 130. The C-plate compensation layer 105 is a uniaxial compensation film and retardation values provided in a direction in a plane are the same (nₓ=n_{y}), and a negative type of C-plate compensation layer of which a retardation value in a vertical direction is smaller (nₓ=n_{y}>n_{z}) than the retardation values in the plane is used. By definition, the retardation values provided in the direction in the plane are the same (nₓ=n_{y}), but an actually-manufactured C-plate compensation layer 105 may have a slight difference between nₓ and n_{y}. The C-plate compensation layer 105 may have an out-of-plane retardation (Rₜₕ) value of 130 nm to 300 nm, and it preferably has an in-plane retardation (Rₒ) value of 0 nm because the Rₒ value is a difference between nₓ and n_{y} by definition, but an actually-manufactured C-plate compensation layer 105 may have a small value. When the Rₒ value increases, since display quality may deteriorate, the C-plate compensation layer 105 having an allowable Rₒ value is used in some display devices. In the present exemplary embodiment, the C-plate compensation layer 105 having the Rₜₕ value of 220 nm is used.

The C-plate compensation layer 105 may be formed as a film type and attached to the lower portion of the TFT substrate (not shown). In some exemplary embodiments, it may be positioned inside the TFT substrate (not shown). The C-plate compensation layer 105 positioned inside the TFT substrate (not shown) may be positioned on a transparent part of the TFT substrate (not shown) to be positioned below or on the thin film transistor. The C-plate compensation layer 105 may be formed by coating a material providing the retardation, arranging the material in a predetermined direction, and then fixing it. For example, the C-plate compensation layer 105 may be formed by arranging a liquid crystal material by rubbing or light-aligning the liquid crystal material in a predetermined direction while coating the liquid crystal material, and then fixing it by heat treatment. In this case, the retardation value provided by the C-plate compensation layer 105 may be adjusted by adjusting a thickness of the coated material.

The upper panel 200 includes the color conversion layer 230, the light blocking layer 220, and the upper polarizer 210. The upper panel 200 also includes a transparent substrate (not shown), the light blocking layer 220 and the color conversion layer 230 may be positioned inside the transparent substrate, and the upper polarizer 210 may be positioned thereunder.

The light blocking layer 220 divides regions in which respective color conversion layers 230 are formed, so that light passing through the adjacent color conversion layers 230 is not mixed.

The red, green, and blue color conversion layers 230 are alternately arranged in respective regions divided by the light blocking layer 220. The red, green, and blue color conversion layers 230 may be variously arranged.

The red and green color conversion layers include semiconductor nanocrystals that convert light provided by the backlight unit 2000 into red and green light, respectively, and in some embodiments, a blue light cutting filter may be included therein. The blue light cutting filter may include a yellow color filter to convert the blue light provided by the backlight unit 2000 into white light. On the other hand, the blue light cutting filter may serve to prevent blue light that has not been converted from being emitted while passing through the red and green color conversion layers 230.

The blue color conversion layer 230 may be made of a transparent material. That is, the blue color conversion layer 230 displays a blue color by emitting the blue light provided by the backlight unit 2000 as it is. No layer therefor may be formed, and in some exemplary embodiments, the blue color conversion layer 230 may be formed as a transparent film to eliminate a step difference.

The upper polarizer 210 is positioned under the light blocking layer 220 and the color conversion layer 230.

The upper polarizer 210 has a transmissive axis in one direction, and blocks light in a direction perpendicular to the transmissive axis. In the exemplary embodiment of FIG. 13, the transmissive axis of the upper polarizer 210 is perpendicular to the transmissive axis of the lower polarizer 110. Accordingly, when an electric field is not applied to a display device using a vertically aligned liquid crystal, light entering the upper polarizer 210 from a lower portion is blocked without being emitted to the outside, thus black is displayed.

The upper polarizer 210 may be attached as a film type, may be coated with a polymeric material, or may be formed with a plurality of metal wires having minute intervals. The plurality of metal wires may have a structure to be arranged in one direction at intervals that are narrower than a wavelength of light.

A common electrode (not shown) may be positioned inside the upper polarizer 210. A common electrode of the upper panel 200 and the pixel electrode of the lower panel 100 generate an electric field.

The liquid crystal layer 300 is positioned between the lower panel 100 and the upper panel 200. The liquid crystal layer 300 may provide retardation of 240 nm to 350 nm with respect to the blue light provided by the backlight unit 2000, and in the present exemplary embodiment, the liquid crystal layer 300 provides retardation of 280 nm.

The liquid crystals in the liquid crystal layer 300 are vertically arranged when no electric field is applied, and the liquid crystals rotate to be horizontally arranged when an electric field is applied.

With regard to the exemplary embodiment of FIG. 13, the polarization characteristics that are changed are not shown in a separate spherical coordinate diagram. In both the exemplary embodiment of FIG. 1 and the exemplary embodiment of FIG. 8, regardless of whether the C-plate compensation layer is positioned on the upper panel 200 or the lower panel 100, the light of the “A” position (polarization that forms an angle of 90° with respect to the transmissive axis of the upper polarizer 210 when viewed from the lateral surface) on the spherical coordinate diagram enters the upper polarizer 210. Therefore, in the exemplary embodiment of FIG. 13, light having the same polarization characteristic as that of the exemplary embodiment of FIG. 11 enters the upper polarizer 210. Thus, even in the exemplary embodiment of FIG. 13, the light at the “A” position on the spherical coordinate diagram is incident on the upper polarizer 210, and the light obliquely entering the lateral surface is blocked, so that the light leakage at the lateral surface also decreases. As a result, black brightness does not increase even when the Lambertian radiation characteristic of the semiconductor nanocrystals of the color conversion layer 230 is considered. Accordingly, the contrast ratio is also improved in the display device of FIG. 13.

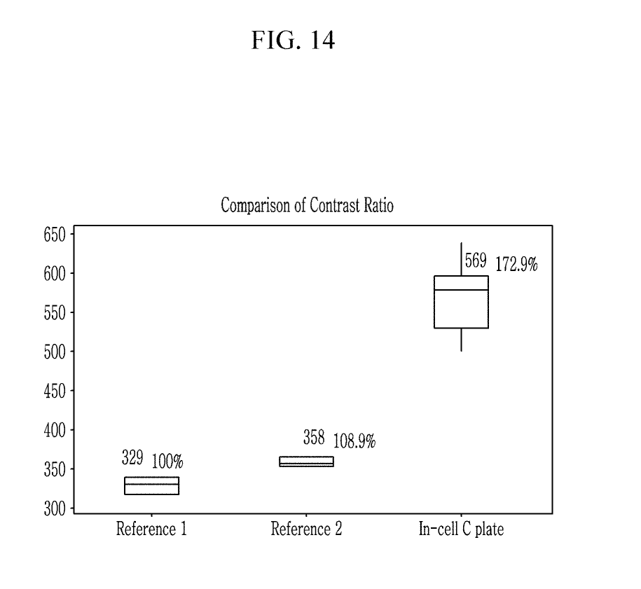

FIG. 14 is a graph for comparing differences of a contrast ratio between an exemplary embodiment of the present invention and a comparative example.

A vertical axis of the graph of FIG. 14 represents the contrast ratio, and three examples are shown in FIG. 14.

In FIG. 14, “Reference 1” is a comparative example in which a negative type of C plate is attached onto the color conversion layer in a form of a film, and specifically, in which one film is attached.

“Reference 2” is a comparative example in which a negative type of C plate is attached onto the color conversion layer in a form of a film as in Reference 1, and specifically, in which two films are attached for improving the compensation characteristic.

In FIG. 14, “In-cell C plate” is an exemplary embodiment of the present invention in which a negative type of C plate is formed inside the color conversion layer. In this case, an Rₜₕ value thereof is 140 nm, and an Rₒ value is a small value close to 0.

All of Reference 1, Reference 2, and the In-cell C plate include a B-plate.

As shown in FIG. 14, since the C plate is formed inside the color conversion layer, it is possible to eliminate the lateral light leakage, and accordingly, the light emitted to the front is reduced by the semiconductor nanocrystals, thereby reducing the black luminance.

However, although the C plate is used, when it is positioned above (or outside) the color conversion layer, the contrast ratio is reduced. This is due to light leaking into the color conversion layer. Referring to FIG. 14, the present exemplary embodiment (in which the C plate is formed below the color conversion layer) has a contrast ratio of 170 times or more greater than that in Reference 1 (in which the C plate is formed above the color conversion layer).

FIG. 14 shows the exemplary embodiment and the comparative example of which each contrast ratio has a predetermined numerical value range, and it shows the experimental results measured while changing a thickness of the liquid crystal layer. It can be seen that the contrast ratio of the present exemplary embodiment is significantly improved even when the thickness of the liquid crystal layer is changed.

Since each of Reference 1, Reference 2, and the In-cell C plate includes the B-plate, the effect of when the A-plate is used is not shown. However, since the A plate is the uniaxial film, it may more easily optimize the compensation compared to the B plate that is the biaxial film. This is because the number of axes to be considered is reduced.

Thus, even in an exemplary embodiment using the A plate, since it is possible to prevent light from leaking to the lateral surface of the upper polarizer, the contrast ratio is improved because luminance of black is not increased even though the light transmits through the color conversion layer.

According to the inventive concepts, when a black color is displayed on a liquid crystal display having a color conversion layer using a semiconductor nanocrystal, lateral light leakage generated in an upper polarizer is reduced, and accordingly, light passing through the color conversion layer is also reduced, thereby reducing black brightness. Accordingly, a contrast ratio is improved in the liquid crystal display having the color conversion layer.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid crystal display comprising:
a display panel comprising an upper panel, a lower panel, and a liquid crystal layer disposed between the upper panel and the lower panel; and
a backlight unit configured to provide light to the display panel,
wherein:
the upper panel includes a color conversion layer and an upper polarizer that respectively include semiconductor nanocrystals;
the lower panel includes a B-plate compensation layer and a lower polarizer;
at least one of the upper panel and the lower panel includes a negative type of C-plate compensation layer;
the upper polarizer is disposed at a lower portion of the color conversion layer; and
the negative type of C-plate compensation layer is disposed between the upper polarizer and the lower polarizer, and is disposed on the upper panel or the lower panel.

2. The liquid crystal display of claim 1, wherein an Rₜₕ (out-of-plane retardation) value of the negative type of C-plate compensation layer is in a range of 80 nm to 200 nm.

3. The liquid crystal display of claim 2, wherein:
the B-plate compensation layer has an optically biaxial characteristic;
an Rₒ (in-plane retardation) value thereof is in a range of 40 nm to 100 nm; and
an Rₜₕ (out-of-plane retardation) value thereof is in a range of 80 nm to 190 nm.

4. The liquid crystal display of claim 3, wherein:
the backlight unit is configured to provide blue light to the display panel; and
the blue light has a wavelength in a range of 430 nm to 465 nm.

5. The liquid crystal display of claim 4, wherein:
the liquid crystal layer contains liquid crystal molecules;
the liquid crystal molecules are vertically arranged when an electric field is not applied thereto; and
the liquid crystal layer causes retardation of 240 nm to 350 nm in total with respect to the blue light provided by the backlight unit.

6. The liquid crystal display of claim 1, wherein:
when viewed from a lateral surface at a predetermined position, an angle formed by a transmissive axis of the upper polarizer based on a transmissive axis of the lower polarizer is referred to as a lateral transmissive angle; and
light vertically polarized with respect to the lateral transmissive angle is incident on the upper polarizer when black is displayed.

7. The liquid crystal display of claim 6, wherein the lateral surface at the predetermined position is disposed in a region in which an amount of lateral light leakage is large.

8. The liquid crystal display of claim 1, wherein:
the upper panel includes the negative type of C-plate compensation layer;
in the upper panel, the negative type of C-plate compensation layer is disposed at a lower portion of the upper polarizer; and
in the lower panel, the B-plate compensation layer is disposed at an upper portion of the lower polarizer.

9. The liquid crystal display of claim 1, wherein:
the lower panel includes the negative type of C-plate compensation layer; and
in the lower panel, the B-plate compensation layer is disposed at an upper portion of the lower polarizer and the negative type of C-plate compensation layer is disposed at an upper portion of the B-plate compensation layer.

10. The liquid crystal display of claim 1, wherein:
the negative type of C-plate compensation layer is formed by coating a material causing retardation thereat; and
the semiconductor nanocrystals of the color conversion layer have a Lambertian radiation characteristic to emit obliquely emitted light toward a front surface.

11. A liquid crystal display comprising:
a display panel including an upper panel, a lower panel, and a liquid crystal layer disposed between the upper panel and the lower panel; and
a backlight unit configured to provide light to the display panel,
wherein the upper panel includes a color conversion layer and an upper polarizer that respectively include semiconductor nanocrystals,
the lower panel includes an A-plate compensation layer and a lower polarizer,
at least one of the upper panel and the lower panel includes a negative type of C-plate compensation layer,
the upper polarizer is disposed at a lower portion of the color conversion layer, and
the negative type of C-plate compensation layer is disposed between the upper polarizer and the lower polarizer, and is disposed on the upper panel or the lower panel.

12. The liquid crystal display of claim 11, wherein an Rₜₕ (out-of-plane retardation) value of the negative type of C-plate compensation layer is in a range of 130 nm to 300 nm.

13. The liquid crystal display of claim 12, wherein:
the A-plate compensation layer has an optically biaxial characteristic;
an Rₒ (in-plane retardation) value thereof is in a range of 70 nm to 180 nm; and
an Rₜₕ (out-of-plane retardation) value thereof is in a range of 10 nm to 90 nm.

14. The liquid crystal display of claim 13, wherein:
the backlight unit is configured to provide blue light to the display panel; and
the blue light has a wavelength in a range of 430 nm to 465 nm.

15. The liquid crystal display of claim 14, wherein:
the liquid crystal layer contains liquid crystal molecules;
the liquid crystal molecules are vertically arranged when an electric field is not applied thereto; and
the liquid crystal layer causes retardation of 240 nm to 350 nm in total with respect to the blue light provided by the backlight unit.

16. The liquid crystal display of claim 11, wherein:
when viewed from a lateral surface at a predetermined position, an angle formed by a transmissive axis of the upper polarizer based on a transmissive axis of the lower polarizer is referred to as a lateral transmissive angle; and
light vertically polarized with respect to the lateral transmissive angle is incident on the upper polarizer when black is displayed.

17. The liquid crystal display of claim 16, wherein the lateral surface at the predetermined position is disposed in a region in which an amount of lateral light leakage is large.

18. The liquid crystal display of claim 11, wherein:
the upper panel includes the negative type of C-plate compensation layer;
in the upper panel, the negative type of C-plate compensation layer is disposed at a lower portion of the upper polarizer; and
in the lower panel, the A-plate compensation layer is disposed at an upper portion of the lower polarizer.

19. The liquid crystal display of claim 11, wherein:
the lower panel includes the negative type of C-plate compensation layer; and
in the lower panel, the A-plate compensation layer is disposed at an upper portion of the lower polarizer, and the negative type of C-plate compensation layer is disposed at an upper portion of the A-plate compensation layer.

20. The liquid crystal display of claim 11, wherein:
the negative type of C-plate compensation layer is formed by coating a material causing retardation thereat; and
the semiconductor nanocrystals of the color conversion layer have a Lambertian radiation characteristic to emit obliquely emitted light toward a front surface.
